(19) United States
(12) Patent Application Publication
(10) Pub. No.: US 2013/0198362 A1
(43) Pub. Date: Aug. 1, 2013

(54) System for Identifying a Server to be Decommissioned

(71) Applicants: Tamer E. Abuelsaad, Poughkeepsie, NY (US); John E. Moore, JR., Brownsburg, IN (US); Rajeshkumar N. Singi, Marietta, GA (US); Robert R. Wentworth, (US)

(72) Inventors: Tamer E. Abuelsaad, Poughkeepsie, NY (US); John E. Moore, JR., Brownsburg, IN (US); Rajeshkumar N. Singi, Marietta, GA (US); Robert R. Wentworth, (US)

(73) Assignee: International Business Machines Corporation, Armonk, NY (US)

(21) Appl. No.: 13/359,402

(22) Filed: Jan. 26, 2012

(51) Int. Cl. G06F 15/173

(52) U.S. Cl. 709/224

(57) ABSTRACT

An embodiment of the invention provides a device for monitoring activity of a computing device connected to a network cable. The device includes a first interface for connecting the device to the network cable, a second interface for connecting the device to the computing device, and a third interface for connecting the device to a power cable. The device includes a first sensor for measuring network traffic to the computing device and/or network traffic from the computing device. The first sensor identifies an IP address accessing the computing device and/or a protocol used to access the computing device. The device further includes a second sensor for measuring power consumption of the computing device and a third sensor for identifying the computing device. A wireless communications module connected to the first sensor and/or the second sensor wirelessly transmits data from the first sensor and/or the second sensor to an external device.

### BACKGROUND

The present invention is in the field of systems, methods, and computer program products for identifying a server to be decommissioned.

A datacenter is a facility equipped with computing devices and electronic components. Datacenters have thousands of server devices. A rack server is a computing system including a plurality of server devices.

In many cases these servers are managed remotely without physical access for many years (e.g., more than 10 years).

### SUMMARY OF THE INVENTION

An embodiment of the invention provides a device for monitoring activity of a computing device connected to a network cable. More specifically, the device includes a first interface for connecting the device to the network cable, a second interface for connecting the device to the computing device, and a third interface for connecting the device to a power cable. The device includes a first sensor for measuring network traffic to the computing device and/or network traffic from the computing device. The device further includes a second sensor for measuring power consumption of the computing device and a third sensor for identifying the computing device.

In another embodiment, a system for monitoring activity of a computing device connected to a network cable includes an adapter connected to the computing device. The adapter includes a sensor for measuring network traffic to the computing device and/or network traffic from the computing device, and a wireless communications module connected to the first sensor. The system further includes a receiver for receiving data from the wireless communications module, and a decision engine connected to the receiver. The decision engine compares the network traffic to the computing device and/or the network traffic from the computing device to a threshold to determine whether the computing device should be decommissioned.

Another embodiment of the invention provides a method for monitoring activity of a computing device connected to a network cable. More specifically, an adapter is connected to a network interface of the computing device, wherein the adapter includes a first sensor and a second sensor. The adapter is connected to: a power interface of the computing device, the network cable, and a power cable. Network traffic to the computing device and/or network traffic from the computing device is measured with the first sensor; and, power consumption of the computing device is measured with the second sensor.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a front view of a device for monitoring activity of a computing device, the device including a network cable interface and a power cable interface, according to an embodiment of the invention;

FIG. 2 illustrates a rear view of the device illustrated in FIG. 1, the device including a computing device interface, according to an embodiment of the invention;

FIG. 3 illustrates a side view of the device illustrated in FIG. 1 according to an embodiment of the invention;

FIG. 4 illustrates a device connected to a computing device, a network cable, and a power cable according to an embodiment of the invention;

FIG. 5 is a flow diagram illustrating a method for monitoring activity of a computing device according to an embodiment of the invention;

FIG. 6 illustrates a system for identifying a server to be decommissioned according to an embodiment of the invention; and

FIG. 7 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a device to monitor power consumption and network activity to aid in determining if a server (also referred to herein as a “computing device”) is truly being used without logging into the server, thereby enabling a determination of whether to decommission the server. The device is inserted in or on a network adapter and/or power supply to measure network traffic flowing over the network cable and/or the amount of electricity being used by the server to determine if the server is really being used. In at least one embodiment of the invention, in order to identify who owns an ‘unknown’ server in the datacenter, the device captures the Internet Protocol (IP) addresses and/or type(s) of traffic (e.g., ICMP, UDP/TCP, port) to and from the server to determine who is using the server. The IP address can then be used to query an IP address registry, whether public or private, if one exits.

The device can also include a radio-frequency identification (RFID) reader for reading an RFID tag on the server. Thus, unique information about the server can be obtained from the RFID tag, such as, for example, the identification number, physical location, machine type, model type, and/or serial number of the server.

The measurement and RFID data is sent to an information warehouse or a database having a historical repository (also referred to herein as an “external device”) for asset management. Such data transmissions can be sent to the external device at regular intervals, for example, as determined by the RFID tag. In another embodiment, the data is sent to the external device when network traffic and/or power measurements fall below a threshold level, above a threshold level, or the data is sent continuously. In another embodiment, the data is sent to the external device when network traffic and/or power measurements fall below a threshold level or are above a threshold level for a predetermined amount of time (e.g., the network traffic is below 10 Megabytes for a 24 hour period). Threshold level(s) can be defined by the administrator and/or a user of the computing device. Some servers (CPU's) throttle down microchips and hard drives to lower consumption when not being used, thus drawing less power from the power cord.

Using this information, a datacenter administrator can determine if a server is being used or if it is a good candidate for sunset/decommissioning. For instance, the administrator can determine that a server is idle if the network traffic and power measurements fall below threshold levels. Moreover, if the database or information warehouse has scripts running against it, over a period of time where a server is below threshold levels, the administrator can determine that the server is no longer being used.

Identifying servers that are good candidates for sunset/decommissioning enables raised floor savings and energy savings as a result of shutting the servers down and removing them from the datacenter floor. By having measurement data collected and stored, an administrator can determine a possible upstream or downstream dependency and thus further help determine if a server can be decommissioned. Additionally, it can help the administrator find associated tape libraries, external attached storage, or other device(s) that can also be decommissioned at the same time.

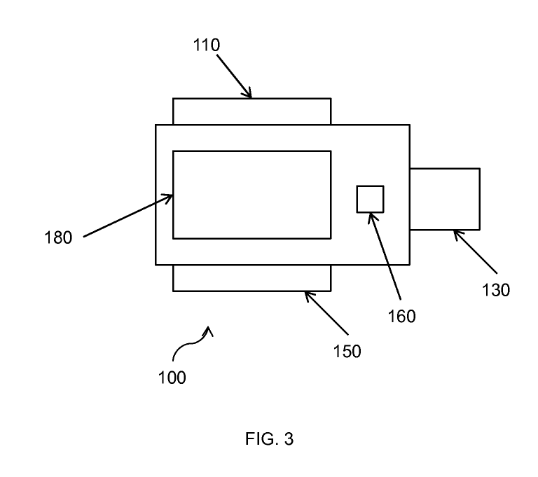

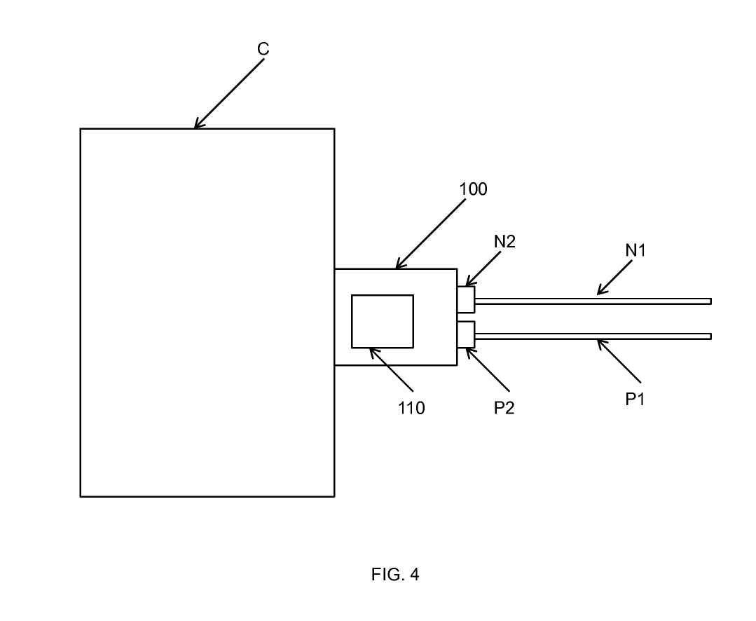

FIGS. 1-4 illustrate a device 100 for monitoring activity of a computing device C connected to a network cable N1 according to an embodiment of the invention. In at least one embodiment, the computing device C is a server in a datacenter. In another embodiment, the computing device C is a workstation in a business office. The device 100 (also referred to herein as an “adapter”) includes a sensor 110 for measuring the network traffic to the computing device C and/or network traffic from the computing device C. As used herein, the term “network traffic” refers to the amount and/or rate that data is sent to or from the computing device C. For example, the sensor 110 measures the number of bits, characters, blocks, and/or packets (e.g., in gigabytes, terabytes, or the like) passing through the device 100. This data can be used by a processor connected to the sensor 110 to calculate the rate that data passes through the device 100. An example of a sensor for measuring the network traffic includes the RealSecure® server sensor (available from International Business Machines, Armonk, N.Y., USA).

The device 100 also includes a first interface 120 for connecting the device 100 to a network connector N2 of the network cable N1. As used herein, the term “connected” includes operationally connected, logically connected, in communication with, physically connected, engaged, coupled, contacts, linked, affixed, and attached. The network connector N2 is a male plug and the first interface 120 is a female socket configured to receive the male plug. In one embodiment, the network connector N2 is a crimp type modular plug (e.g., 8P8C plug, 6P6C plug, 6P4C plug, 4P4C plug) that is crimped onto the network cable N1 (e.g., coaxial cable, optical fiber cable, twisted pair cables, patch cable, Ethernet crossover cable). For example, in one embodiment, the network connector N2 is an 8P8C plug and the first interface 120 is an 8P8C socket. In another embodiment, the network connector N2 is integrally formed with the network cable N1 such that the network cable is a single structure which includes a network connector for connecting to the device 100.

As illustrated in FIG. 4, in at least one embodiment, the device 100 is directly connected to the network connector N2. As used herein, the term “directly connected” refers to an arrangement where two components are directly attached to one another without any intervening components, such that the two components physically contact one another. Thus, for example, as illustrated in FIG. 4, the network connector N2 is directly connected to the device 100; and, the network cable N1 is indirectly connected to the computing device C (via the network connector N2 and the device 100).

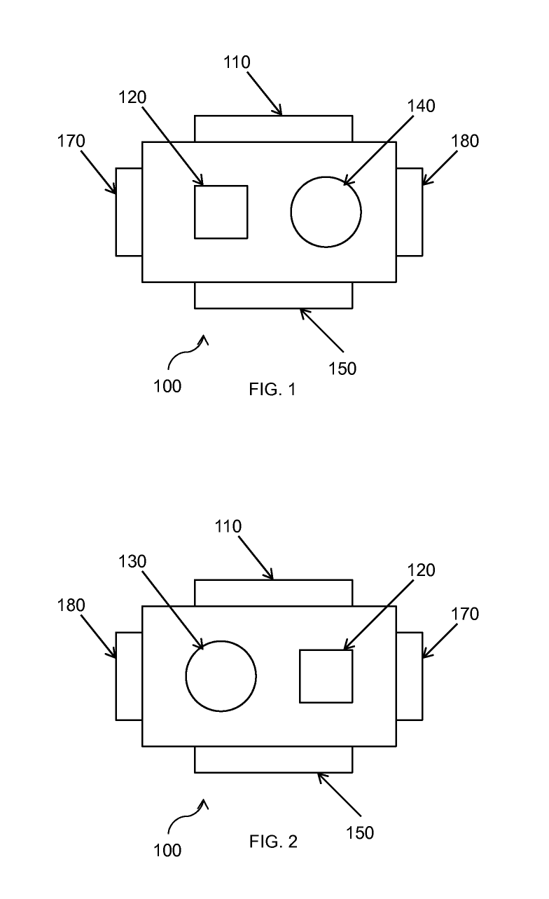

As illustrated in FIG. 2, the device 100 includes a second interface 130 for connecting the device 100 to the computing device C. In at least one embodiment, the second interface 130 is a plug (e.g., Universal Serial Bus plug, 8P8C plug) adapted to connect to a network socket on the computing device C. As illustrated in FIG. 4, in one embodiment of the invention, the device 100 is directly connected to the computing device C. In another embodiment, the device 100 is indirectly connected to the computing device C via an intervening cable (not shown).

In at least one embodiment of the invention, the device 100 includes a third interface 140 for connecting the device 100 to a power cable P1. The third interface 140 is a socket configured to receive a plug P2 (e.g., 5.5 mm power plug) of the power cable P1. As illustrated in FIG. 2, the device 100 further includes a fourth interface 142 that connects the device 100 to the computing device C. In at least one embodiment, fourth interface 142 is a plug (e.g., Universal Serial Bus plug, 8P8C plug) adapted to connect to a power interface (e.g., socket) on the computing device C. It is recognized that different embodiments of the device can include different dimensioned third and fourth interfaces to correspond with different sized power plugs and sockets. Thus, in at least one embodiment, the second interface 130 provides both network connectivity and power to the computing device C.

The device 100 includes a second sensor 150 for measuring power consumption of the computing device C. In other words, the second sensor 150 detects the amount of electricity that passes from the power cable P1, through the device 100, and into the computing device C. In one embodiment, the device 100 includes an internal power source (e.g., battery) for supplying power to the sensor 110 and second sensor 150. In another embodiment, the device 100 draws power from the power cable P1, wherein a processor of the device 100 factors the power consumption of the device 100 into the calculation of the power consumption of the computing device C.

The device 100 further includes a wireless communications module 160 for wirelessly transmitting measurement data from the sensor 110 and/or second sensor 150 to an external device. In another embodiment, the measurement data is sent to the external device through the network cable N1. In at least one embodiment, the external device is monitored by an administrator of a datacenter and/or an automated decision engine to determine whether a computing device (e.g., server) should be decommissioned.

In at least one embodiment of the invention, the device 100 further includes a third sensor 170 for identifying the computing device C, wherein the third sensor is a radio-frequency identification (RFID) sensor. In another embodiment, the third sensor 170 identifies the device identifier (e.g., IP address or media access control (MAC) address) of the device accessing the computing device and/or protocol used to access the computing device. Data from the third sensor 170 can be sent to an external device via the wireless communications module 160. It is recognized that in at least one embodiment of the invention, the device 100 lacks the third interface 140, fourth interface 142, second sensor 150, and/or third sensor 170.

The device 100 further includes a processor 180 for comparing the network traffic to the computing device C and/or the network traffic from the computing device C to one or more thresholds to determine whether the computing device C should be decommissioned. In one embodiment, the processor 180 compares the power consumption of the computing device C to one or more thresholds to determine whether the computing device C should be decommissioned. The threshold level(s) can be defined by an administrator of a datacenter, administrator of a workstation, and/or a user of the computing device. In another embodiment, the determination of whether the computing device C should be decommissioned is performed by an external device.

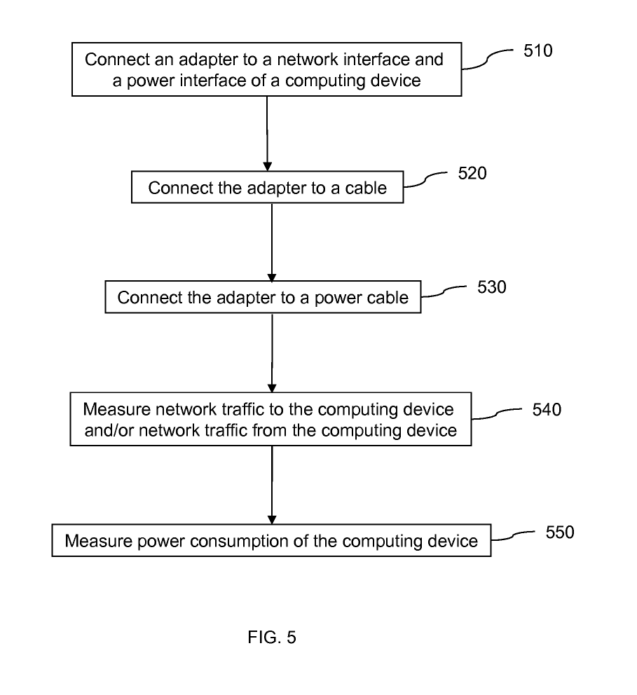

FIG. 5 is a flow diagram illustrating a method for monitoring activity of a computing device connected to a network cable according to an embodiment of the invention. In at least one embodiment, the computing device is a server in a datacenter. In another embodiment, the computing device is a workstation in a business office. An adapter (e.g., the device 100) is connected to a network interface (e.g., 8P8C socket) and a power socket (5.5 mm power socket) of the computing device 510, wherein the adapter includes a sensor. The adapter is further connected to a network connector (e.g., 8P8C plug) of the network cable 520, such that the network connector is directly attached to and contacts the adapter. Furthermore, the adapter is connected to a power cable 530. The network traffic to the computing device and/or network traffic from the computing device is measured with the sensor 540. The power consumption of the computing device is also measured 550 (with the sensor or a second sensor).

In at least one embodiment of the invention, the computing device is identified with an RFID sensor of the adapter. In another embodiment, an IP address accessing the computing device, a MAC address accessing the computing device, and/or a protocol used to access the computing device is identified with the sensor or a third sensor.

A wireless data transmission is received from the adapter, wherein the wireless data transmission includes the measured network traffic to the computing device and/or the measured network traffic from the computing device. In another embodiment, the wireless data transmission includes the identity of the computing device and/or the measured power consumption of the computing device.

The network traffic to the computing device and/or the network traffic from the computing device are compared to threshold(s) to determine whether the computing device should be decommissioned. In another embodiment, the measured power consumption is compared to a threshold to determine whether the computing device should be decommissioned. For example, a datacenter administrator compares the measured network traffic from the computing device (258 gigabytes) to a network traffic threshold (500 gigabytes) and determines that the computing device should be decommissioned. In another example, an automated decision engine connected to the external device compares the measured power consumption from the computing device (12 gigawatts per week) to a power consumption threshold (50 gigawatts per week) and determines that the computing device should be decommissioned.

In at least one embodiment of the invention, the power consumption, network traffic to the computing device, and/or the network traffic from the computing device are monitored during a predefined time period to identify unauthorized access or use of the computing device. For example, if the power consumption, network traffic to the computing device, and/or the network traffic from the computing device is detected to rise above a predefined threshold (e.g., 50 gigabytes of data movement) during a predefined time period (e.g., 6:00 PM-6:00 AM), then an alert is triggered (e.g., an e-mail is sent to a datacenter administrator notifying the administrator that the threshold was exceeded).

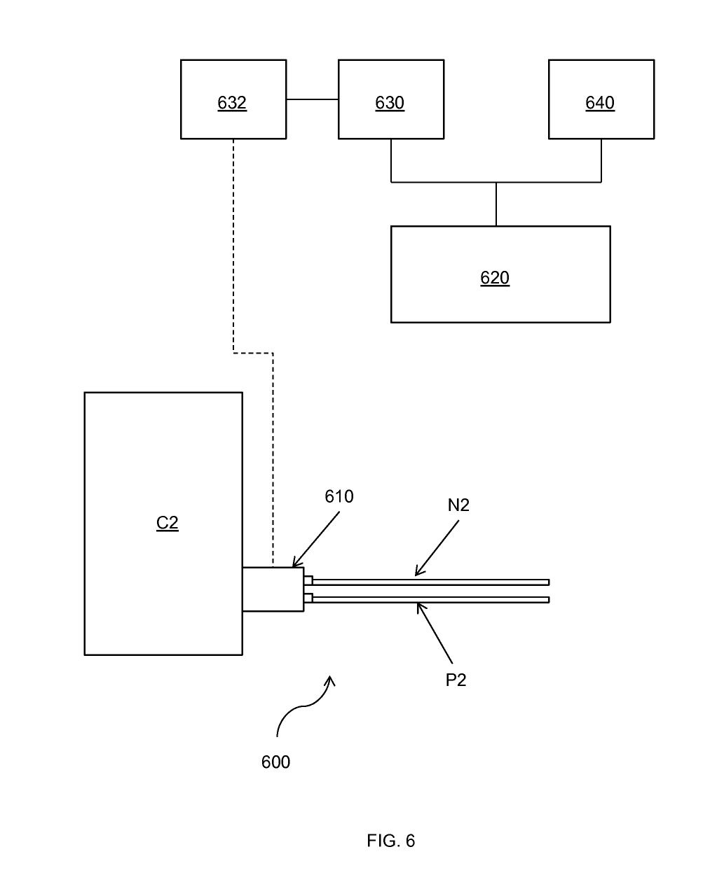

FIG. 6 illustrates a system 600 for identifying a server to be decommissioned according to an embodiment of the invention. The system 600 includes and an adapter 610 connected to a network cable N3, a power cable P2, and a computing device C2. As described more fully above with reference to the device 100, the adapter 610 measures the network traffic flowing to and from the computing device C2. Additionally, the adapter 610 measures the amount of electricity flowing to the computing device C2.

The system 600 further includes a decision engine 620 connected to a monitoring database 630 and a device registry 640. The adapter 610 sends measured data to a receiver 632 connected to the monitoring database 630. In at least one embodiment, the adapter 610 includes a wireless transmitter (not shown) for sending the measured network traffic and power consumption data to the receiver 632.

The measured network traffic and power consumption data is sent from the monitoring database 630 to the decision engine 620. In at least one embodiment, the adapter 610 also sends data relating to the computing device C2 to the receiver 632 (e.g., the identification number of the computing device C2). As described above, the adapter 610 can include an RFID reader for reading RFID tags on computing devices. This additional data is also sent from the monitoring database 630 to the decision engine 620.

The decision engine 620 also receives the server name and/or physical location of the server on the raised floor (including rack information) from the device registry 640. Based on the data it receives from the monitoring database 630 and device registry 640, the decision engine 620 determines whether the computing device C2 should be decommissioned. For example, if the measured amount of electricity flowing to the computing device C2 is below a predetermined threshold, then the decision engine 620 determines that the computing device C2 should be decommissioned. In another example, if the measured network traffic to and from the computing device C2 is above a predetermined threshold, then the decision engine 620 determines that the computing device C2 should not be decommissioned.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

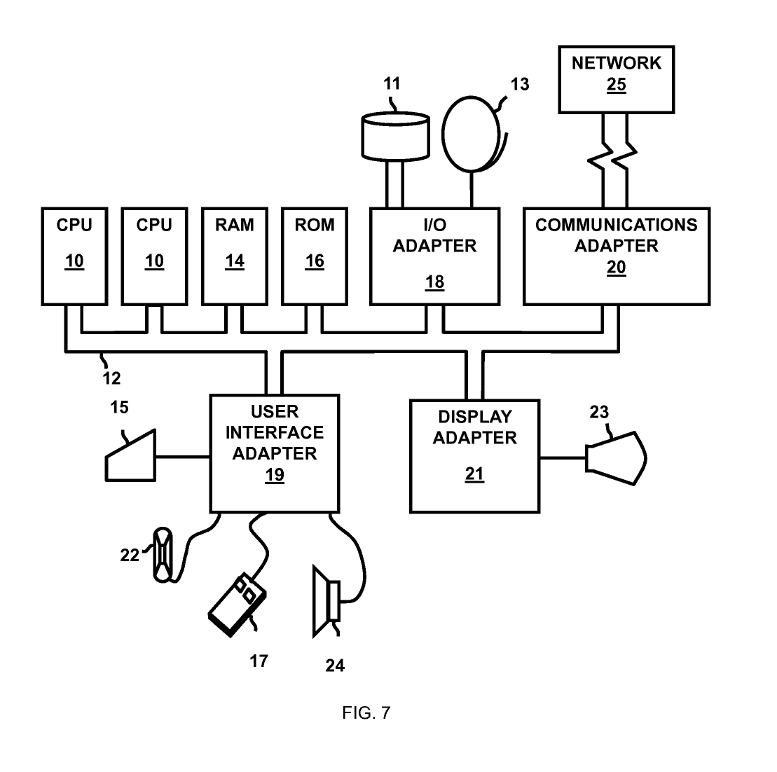

Referring now to FIG. 7, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device for monitoring activity of a computing device connected to a network cable, said device comprising:
a first interface for connecting said device to the network cable;
a second interface for connecting said device to the computing device;
a third interface for connecting said device to a power cable;
a first sensor for measuring at least one of network traffic to the computing device and network traffic from the computing device; and
a second sensor for measuring power consumption of the computing device.

2. The device according to claim 1, wherein said first sensor identifies a device identifier of a device accessing the computing device.

3. The device according to claim 1, wherein said first sensor identifies at least one protocol used to access the computing device.

4. The device according to claim 1, further comprising a wireless communications module connected to at least one of said first sensor and said second sensor, said wireless communications module wirelessly transmits data from at least one of said first sensor and said second sensor to an external device.

5. The device according to claim 1, further comprising a third sensor for identifying the computing device, wherein said third sensor is an RFID sensor.

6. The device according to claim 1, wherein the computing device is a server in a datacenter.

7. The device according to claim 1, further comprising a processor connected to said first sensor, said processor compares at least one of the network traffic to the computing device and the network traffic from the computing device to a threshold to determine whether the computing device should be decommissioned.

8. The device according to claim 1, further comprising a processor connected to said second sensor, said processor compares the power consumption of the computing device to a threshold to determine whether the computing device should be decommissioned.

9. An adapter for monitoring activity of a server connected to a network cable, said adapter comprising:
a first interface for connecting said adapter to the network cable;
a second interface for connecting said adapter to the server;
a third interface for connecting said adapter to a power cable;
a first sensor for measuring at least one of network traffic to the server and network traffic from the server;
a second sensor for measuring power consumption of the server; and
a third sensor for identifying the server.

10. The adapter according to claim 9, further comprising a wireless communications module for wirelessly transmitting at least one of:
at least one measurement from said first sensor to an external device;
at least one measurement from said second sensor to the external device; and
data from said third sensor to the external device.

11. The adapter according to claim 9, wherein said first sensor identifies at least one of an IP address accessing the computing device, a MAC address accessing the computing device, and a protocol used to access the computing device.

12. The adapter according to claim 9, further comprising a processor connected to said first sensor, said processor compares at least one of the network traffic to the computing device and the network traffic from the computing device to a threshold to determine whether the computing device should be decommissioned.

13. The adapter according to claim 9, further comprising a processor connected to said second sensor, said processor compares the power consumption of the computing device to a threshold to determine whether the computing device should be decommissioned.

14. A system for monitoring activity of a computing device connected to a network cable, said system comprising:
an adapter connected to the computing device, said adapter comprising:
a sensor for measuring at least one of network traffic to the computing device and network traffic from the computing device;
a wireless communications module connected to said first sensor;
a receiver for receiving data from said wireless communications module; and
a decision engine connected to said receiver, said decision engine compares at least one of the network traffic to the computing device and the network traffic from the computing device to a threshold to determine whether the computing device should be decommissioned.

15. The system according to claim 14, wherein said sensor identifies a device identifier of a device accessing the computing device.

16. The system according to claim 14, wherein said sensor identifies at least one protocol used to access the computing device.

17. The system according to claim 14, wherein said adapter further comprises a second sensor for measuring power consumption of the computing device.

18. The system according to claim 17, wherein said decision engine compares the power consumption of the computing device to a second threshold to determine whether the computing device should be decommissioned.

19. The system according to claim 14, wherein said adapter further comprises a third sensor for identifying the computing device, wherein said third sensor is an RFID sensor.

20. A method for monitoring activity of a computing device connected to a network cable, said method comprising:
connecting an adapter to a network interface of the computing device, the adapter including a first sensor and a second sensor;
connecting the adapter to a power interface of the computing device, connecting the adapter to the network cable;
connecting the adapter to a power cable;
measuring at least one of network traffic to the computing device and network traffic from the computing device with the first sensor; and
measuring power consumption of the computing device with the second sensor.

21. The method according to claim 20, further comprising receiving a wireless data transmission from the adapter, the wireless data transmission including at least one of the measured network traffic to the computing device, the measured network traffic from the computing device, and the power consumption of the computing device.

22. The method according to claim 20, further comprising identifying at least one of a device identifier of a device accessing the computing device and a protocol used to access the computing device.

23. The method according to claim 20, further comprising identifying the computing device with an RFID sensor of the adapter.

24. The method according to claim 20, further comprising comparing at least one of the network traffic to the computing device and the network traffic from the computing device to a threshold to determine whether the computing device should be decommissioned.

25. The method according to claim 20, further comprising comparing the power consumption of the computing device to a threshold to determine whether the computing device should be decommissioned.
